(19) United States
(12) Patent Application Publication
(10) Pub. No.: US 2023/0024351 A1
(43) Pub. Date: Jan. 26, 2023

(54) FINE PARTICLE MEASURING DEVICE

(71) Applicant: Hitachi Industrial Equipment Systems Co., Ltd., Tokyo (JP)

(72) Inventors: Takeshi KANEKO, Tokyo (JP); Takeshi MATSUMURA, Tokyo (JP)

(73) Assignee: Hitachi Industrial Equipment Systems Co., Ltd., Tokyo (JP)

(21) Appl. No.: 17/826,316

(22) Filed: May 27, 2022

(30) Foreign Application Priority Data
Jul. 20, 2021 (JP) 2021-119204

(51) Int. Cl. G01N 15/14

(52) U.S. Cl. CPC G01N 15/1434; G01N 15/1404; G01N 2015/1486; G01N 2015/1006

(57) ABSTRACT

A fine particle measuring device performing fine particle measurement includes a particle probe, a pipe connected to the particle probe, and a particle counter connected to the pipe. A cylindrical pipe is disposed on an outer periphery of the pipe and an air flow path is provided between the pipe and the cylindrical pipe.

### BACKGROUND OF THE INVENTION

### 1. Field of the Invention

The present invention relates to a fine particle measuring device used for cleanliness monitoring during safety cabinet or isolator work and clean room cleanliness monitoring.

### 2. Description of the Related Art

Safety cabinets and isolators are used in handling pathogens and so on for pathogen research such as virus research, pharmaceutical development such as vaccine development, and so on and in work such as cell observation and medium replacement in cell culture in regenerative medicine.

In some safety cabinets and isolators, a particle probe that suctions a sample for fine particle measurement is installed at a representative point in a work chamber for the purpose of cleanliness monitoring during work. A fine particle measuring device for fine particle measurement is constructed by piping connection to a particle probe and particle counter connection. A similar system is constructed for fine particle measurement in a clean room.

JP 2012-73070 A is an example of the fine particle measuring device. Disclosed in JP 2012-73070 A is a fine particle measuring device capable of accurately measuring fine particles by eliminating the effect of optical noise attributable to, for example, laser noise attributable to laser output fluctuations, Rayleigh scattered light emitted from air molecules or the like, or light reflection on a wall surface in an optical system housing.

In the fine particle measuring device disclosed in JP 2012-73070 A, a non-constant velocity suction error attributable to the difference in flow velocity between the main flow in the vicinity of where a particle probe is installed and the inside of the particle probe is not taken into consideration whereas a measurement error attributable to optical noise is taken into consideration.

### SUMMARY OF THE INVENTION

The present invention has been made in view of the above problem, and an object of the present invention is to provide a fine particle measuring device capable of suppressing a non-constant velocity suction error as much as possible.

According to an example of the present invention, a fine particle measuring device performing fine particle measurement includes a particle probe, a pipe connected to the particle probe, and a particle counter connected to the pipe. A cylindrical pipe is disposed on an outer periphery of the pipe and an air flow path is provided between the pipe and the cylindrical pipe.

According to the present invention, it is possible to provide a fine particle measuring device capable of suppressing a non-constant velocity suction error as much as possible.

### BRIEF DESCRIPTION OF THE DRAWINGS

FIGS. 1A and 1B are configuration diagrams in which a fine particle measuring device according to a first embodiment is installed in a safety cabinet;

FIG. 2 is a schematic configuration diagram of the fine particle measuring device according to the first embodiment;

FIG. 3 is a schematic diagram of a flow rate adjustment damper according to the first embodiment;

FIGS. 4A to 4C are diagrams illustrating a non-constant velocity suction error according to the first embodiment; and

FIG. 5 is a schematic configuration diagram of a fine particle measuring device according to a second embodiment.

### DETAILED DESCRIPTION OF THE PREFERRED EMBODIMENTS

Hereinafter, embodiments of the present invention will be described with reference to the drawings.

### First Embodiment

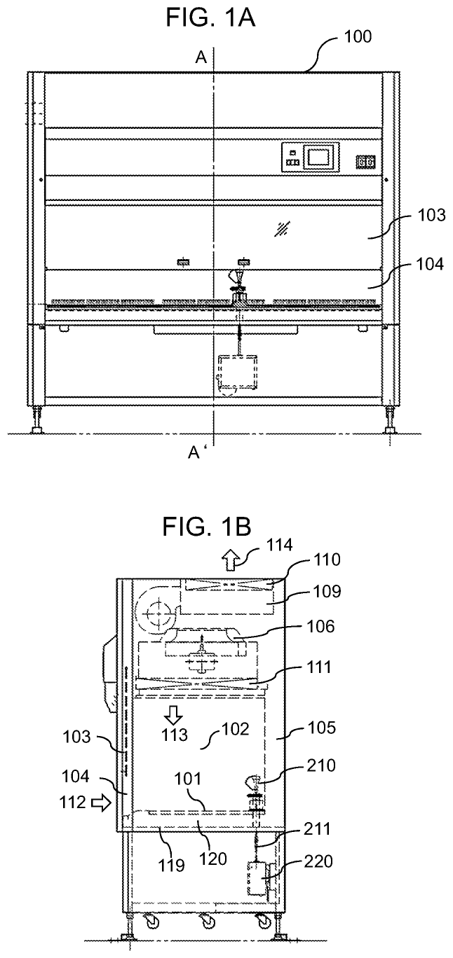

FIGS. 1A and 1B are configuration diagrams in which a fine particle measuring device in the present embodiment is installed in a safety cabinet. In FIGS. 1A and 1B, FIG. 1A is a front view of the safety cabinet, and FIG. 1B is a side view of the safety cabinet in which the A-A′ cross section of FIG. 1A is seen from the right.

As illustrated in FIGS. 1A and 1B, a safety cabinet 100 has a work space 102 therein and the work space 102 has a front surface configured by a front shutter 103. The lower surface of the work space 102 is configured by a workbench 101. A work opening portion 104 is formed below the front shutter 103. A pressure chamber 109 is pressurized in a case where a fan 106 of the safety cabinet is operated. A blowout HEPA filter 111 is connected to the pressure chamber 109. Dust in the pressure chamber 109 is filtered by the blowout HEPA filter 111, clean air is blown out, and the air is supplied into the work space 102 as a blowout airflow 113.

An exhaust HEPA filter 110 is also connected to the pressure chamber 109. The air pressurized in the pressure chamber 109 is filtered by the exhaust HEPA filter 110, passes through the exhaust port of the safety cabinet, and is exhausted from the safety cabinet 100 as exhaust air 114.

Then, air equal in amount to the air exhausted from the safety cabinet 100 enters the safety cabinet 100. The air is an inflow airflow 112 generated in the work opening portion 104 below the front shutter 103. The inflow airflow 112, together with a part of the blowout airflow 113 of the work space 102, passes through an exhaust circulation path 120 formed by the workbench 101 and a drain pan 119 and is suctioned into the fan 106 of the safety cabinet via a back path 105. As a result, the inflow airflow 112 from the work opening portion 104 is discharged without staying in the work space 102 and thus acts as an air barrier for the inflow airflow 112 from the work opening portion 104.

Dust or an aerosol containing a pathogen or the like is handled in the work space 102, and thus dust or an aerosol containing a pathogen or the like is also in the back path 105 and the pressure chamber 109. In supplying air to the work space 102 and in exhausting air from the safety cabinet 100, the dust or aerosol is removed by the blowout HEPA filter 111 and the exhaust HEPA filter 110. A worker sits in front of the safety cabinet 100, inserts an arm into the work space 102 from the work opening portion 104, and works while looking inside the work space 102 through the front shutter 103.

A particle probe 210 suctioning a sample for fine particle measurement is disposed on the back side in the work space 102 of the safety cabinet. The particle probe 210 is connected to a particle counter 220 by an integrated pipe 211 to construct a fine particle measuring device.

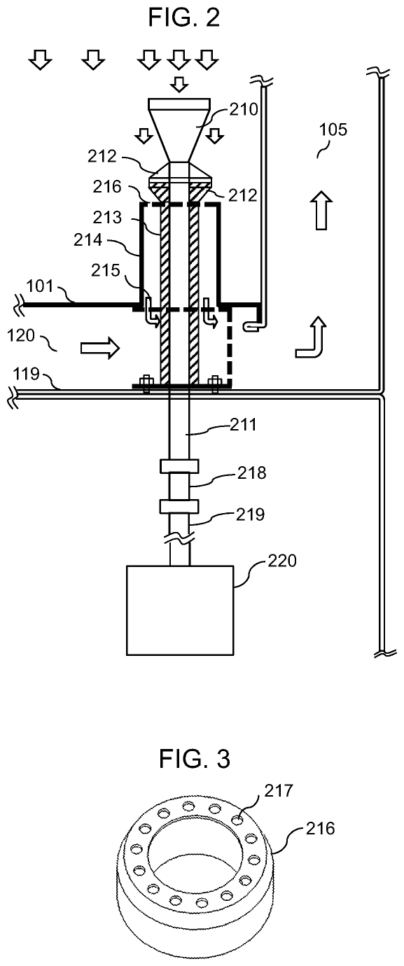

FIG. 2 is a schematic configuration diagram in which the part of the fine particle measuring device in the present embodiment in the side view of FIG. 1B is enlarged. In FIG. 2, the same configurations as those in FIGS. 1A and 1B are denoted by the same reference numerals, and the description thereof will be omitted.

In FIG. 2, the particle probe 210 has a trumpet-shaped tip for suction at a constant velocity. In addition, the pipe 211 integrated with the particle probe is a straight pipe without a bent portion so that particle sedimentation attributable to piping bending is prevented.

The pipe 211 is connected to the particle counter 220 via a union joint 218 using a tube 219 made of, for example, urethane or silicon such that dimensions are adjusted with ease.

When the pump built in the particle counter 220 is started, air for cleanliness measurement is suctioned from the particle probe 210 via the tube 219, the union joint 218, and the pipe 211.

The trumpet-shaped tip of the particle probe 210 is integrated with a part of the connected pipe 211 by welding a first ferrule joint 212 removable with one touch.

Meanwhile, an inner pipe shaft (maintenance pipe) 213 connected to the drain pan 119 and integrated with the safety cabinet main body includes the pipe 211, has a second ferrule joint 212, and is configured such that the particle probe 210 and the pipe 211 can be fixed with a clamp (not illustrated) by the first and second ferrule joints 212.

Further, during maintenance, the particle probe 210 and the pipe 211 can be removed from the inner pipe shaft 213 by removing the clamp with one touch and disconnecting the first and second ferrule joints 212. As a result, in this structure, the particle probe 210 where the pipe 211 passing through the inner pipe shaft 213 is integrated can be easily removed from the safety cabinet main body and can be washed separately.

In addition, by installing a cylindrical pipe (negative pressure suction path) 214 further outside the inner pipe shaft 213 and providing a flow path 215 leading to the exhaust circulation path 120, a negative pressure suction path can be formed, the airflow outside the particle probe 210 can be drawn in, and the main flow in the vicinity of where the particle probe 210 is installed can be suctioned to increase the flow velocity of the main flow. It should be noted that the material of the cylindrical pipe 214 is preferably stainless steel (SUS).

In addition, a flow rate adjustment damper 216 capable of flow rate adjustment is added to the upper end of the cylindrical pipe 214. With the flow rate adjustment damper 216, the flow velocity of the main flow in the vicinity of where the particle probe is installed can be adjusted, the flow velocity of the main flow and the flow velocity in the particle probe can be adjusted equally, and a non-constant velocity suction error as an error in measured concentration attributable to the difference in flow velocity between the main flow and the inside of the particle probe can be suppressed as much as possible.

FIG. 3 is a schematic diagram of the flow rate adjustment damper 216 in the present embodiment. As illustrated in FIG. 3, the flow rate adjustment damper 216 is a rubber cap formed of, for example, rubber as a material and has a plurality of through holes 217, and the flow rate can be adjusted depending on how many through holes 217 are blocked by a closing cap (not illustrated). It should be noted that the flow rate adjustment damper is not limited to FIG. 3 and may be any that is capable of flow rate adjustment, examples of which include a globe valve, a sluice valve, and a ball valve.

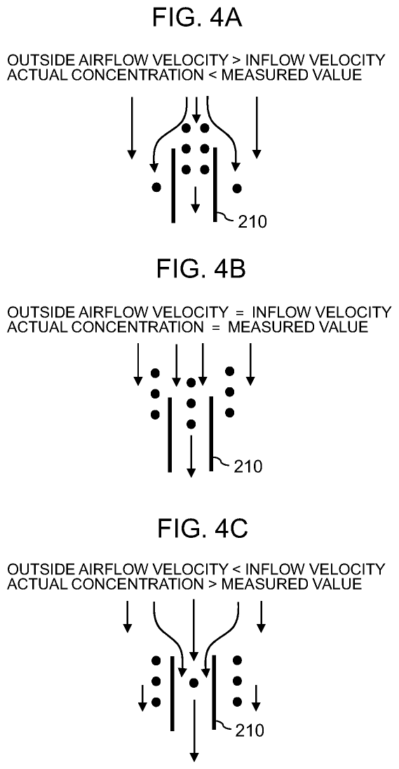

FIGS. 4A to 4C are diagrams illustrating the non-constant velocity suction error in the present embodiment. In the case of intra-airflow particle concentration measurement, an error occurs in the obtained particle concentration when suction is performed at a velocity different from the velocity of the airflow, which is called a non-constant velocity suction error. In other words, when the inflow velocity of the particle probe is different from the outside airflow velocity, the error between the measured value and the actual concentration increases. For example, as illustrated in FIG. 4A, in a case where the inflow velocity of flow into the particle probe 210 is lower than the outside airflow velocity, the particle concentration at the high outside airflow velocity decreases and, as a result, the value measured by the particle probe 210 becomes larger than the actual concentration. In addition, as illustrated in FIG. 4C, in a case where the inflow velocity of flow into the particle probe 210 is higher than the outside airflow velocity, the particle concentration at the high inflow velocity decreases and, as a result, the value measured by the particle probe 210 becomes smaller than the actual concentration. Further, as illustrated in FIG. 4B, in a case where the inflow velocity of flow into the particle probe 210 is equal to the outside airflow velocity, the value measured by the particle probe 210 becomes equal to the actual concentration as a result of constant velocity suction.

In the present embodiment, by setting the diameter of the cylindrical pipe 214 such that the inflow velocity of the particle probe and the outside airflow velocity are equal to each other, the non-constant velocity suction error can be suppressed as much as possible even without the flow rate adjustment damper 216.

Meanwhile, the non-constant velocity suction error can be suppressed more accurately by finely adjusting the flow rate with the flow rate adjustment damper 216. It should be noted that at this time, by setting the diameter of the cylindrical pipe 214 such that the outside airflow velocity, that is, the flow velocity of the main flow in the vicinity of where the particle probe is installed becomes larger than the inflow velocity of the particle probe, a fine adjustment in the direction of decreasing the outside airflow velocity can be made with the flow rate adjustment damper 216.

As described above, according to the present embodiment, it is possible to provide the fine particle measuring device capable of suppressing as much as possible the non-constant velocity suction error in which an error occurs in the obtained measured concentration due to the difference in flow velocity between the main flow in the vicinity of where the particle probe is installed and the inside of the particle probe. In addition, by providing the inner pipe shaft for fixing the pipe outside the pipe integrated with the particle probe, it is possible to provide the fine particle measuring device allowing the particle probe and the pipe to be removed with one touch during maintenance.

### Second Embodiment

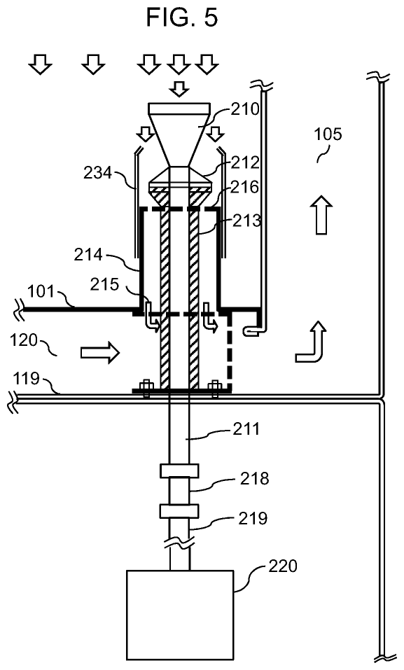

FIG. 5 is a schematic configuration diagram of a fine particle measuring device in the present embodiment. In FIG. 5, the same configurations as those in FIG. 2 are denoted by the same reference numerals, and the description thereof will be omitted.

FIG. 5 differs from FIG. 2 in that the cylindrical pipe 214 is provided with a slide tube 234. The slide tube 234 is configured to be capable of sliding in the longitudinal direction of the particle probe 210 along the cylindrical pipe 214.

By adjusting the slide amount, the slide tube 234 is capable of adjusting the flow velocity of the main flow in the vicinity of where the particle probe 210 is installed that is generated by the cylindrical pipe 214.

As a result, it is possible to provide the fine particle measuring device capable of further suppressing the non-constant velocity suction error with respect to the first embodiment.

Hereinbefore, description has been given of the embodiment, but the present invention includes various modification examples without being limited to the embodiments described above. For example, the embodiments have been described in detail so that the present invention can be understood with ease and are not necessarily limited to having every described configuration.

What is claimed is:

1. A fine particle measuring device performing fine particle measurement and comprising a particle probe, a pipe connected to the particle probe, and a particle counter connected to the pipe,
wherein a cylindrical pipe is disposed on an outer periphery of the pipe and an air flow path is provided between the pipe and the cylindrical pipe.

2. The fine particle measuring device according to claim 1, wherein the flow path between the pipe and the cylindrical pipe is provided with a flow rate adjustment damper.

3. The fine particle measuring device according to claim 1, wherein
an inner pipe shaft fixed at an installation point is provided, and
the inner pipe shaft includes the pipe, has a first joint, and has a configuration in which the particle probe and the pipe can be fixed by the first joint.

4. The fine particle measuring device according to claim 3, wherein
the particle probe has a trumpet shape and a tip of the trumpet shape is integrated with a part of the connected pipe by welding a second joint, and
the particle probe and the pipe are fixed at the installation point via the inner pipe shaft by connecting the first joint and the second joint.

5. The fine particle measuring device according to claim 4, wherein the first joint and the second joint are ferrule joints and are connected by a clamp.

6. The fine particle measuring device according to claim 1, wherein the cylindrical pipe has a slide tube slidable in a longitudinal direction of the particle probe.
